(19) United States
(12) Patent Application Publication
(10) Pub. No.: US 2026/0298160 A1
(43) Pub. Date: Oct. 1, 2026

(54) FUEL SUPPLY SYSTEM, AND VEHICLE

(71) Applicant: ISUZU MOTORS LIMITED, Yokohama-shi (JP)

(72) Inventors: Shinichiro KANEKO, Fujisawa-shi (JP); Yuichi HARA, Fujisawa-shi (JP); Akihiro TAKASHIMA, Fujisawa-shi (JP)

(21) Appl. No.: 19/553,897

(22) Filed: Mar. 2, 2026

(30) Foreign Application Priority Data
Mar. 27, 2025 (JP) 2025-053436

(51) Int. Cl. F02D 19/02; F02M 21/02

(52) U.S. Cl. CPC F02D 19/023; F02D 19/029; F02M 21/0215; F02M 21/0221; F02M 21/0239; F02M 21/0275; F02M 21/0287; F02D 2200/0611

(57) ABSTRACT

A fuel supply system for an engine installed in a vehicle of the present disclosure, the fuel supply system comprising: an LNG tank; a BOG tank connected to a first pipe extending from the LNG tank; a vaporizer connected to a second pipe extending from the LNG tank and vaporizing the LNG fuel; an injection unit connected to the vaporizer and configured to inject the vaporized LNG fuel into a cylinder of the engine; a control valve provided in a third pipe connecting the BOG tank with an intake pipe of the engine; and a control unit that controls the control valve to supply the boil-off gas to the engine in an amount corresponding to an estimated degree of heavy component concentration of the LNG fuel in the LNG tank, when driving the vehicle with the engine using the LNG fuel.

### DESCRIPTION

### TECHNICAL FIELD

The present disclosure relates to a fuel supply system and a vehicle.

### BACKGROUND ART

In recent years, from the viewpoint of preventing environmental pollution, LNG vehicles that run on liquefied natural gas (hereinafter also referred to as "LNG") as fuel have been attracting attention.

This type of vehicle is provided with an LNG tank, and an engine of the vehicle generates driving force by using vaporized LNG fuel taken out of the LNG tank as fuel (see, for example, PTL 1).

### Citation List

### Patent Literature

PTL 1: Japanese Patent Application Laid-Open No. 2020-159278

### SUMMARY OF INVENTION

### Technical Problem

Incidentally, in this type of vehicle, it is known that natural heat input to the LNG tank causes some of the LNG fuel to vaporize, generating boil-off gas (hereinafter also referred to as "BOG").

In this type of vehicle, when boil-off gas is generated and the internal pressure of the LNG tank increases, the boil-off gas is emitted into the atmosphere. However, because boil-off gas is primarily composed of methane, there are concerns that it may cause environmental pollution.

On the other hand, there is also the problem in that the LNG fuel in the LNG tank becomes heavier in composition as a result of boil-off gas vaporizing from the LNG fuel, which makes the engine more susceptible to knocking.

The present invention has been made in view of the above problems. That is, an object of the present invention is to provide a fuel supply system for a vehicle engine, and a vehicle that is capable of suppressing the emission of boil-off gas into the atmosphere and enables effective utilization of the BOG.

### Solution to Problem

A main aspect of the present disclosure for solving the above-described problems is a fuel supply system for an engine installed in a vehicle, the fuel supply system comprising:
an LNG tank for storing LNG (Liquefied Natural Gas) fuel;
a boil-off gas (BOG) tank connected to a first pipe extending from the LNG tank and configured to store boil-off gas vaporized from the LNG fuel in the LNG tank;
a vaporizer connected to a second pipe extending from the LNG tank and vaporizing the LNG fuel;
an injection unit connected to the vaporizer and configured to inject the vaporized LNG fuel into a cylinder of the engine;
a control valve provided in a third pipe connecting the BOG tank with an intake pipe of the engine; and
a control unit that controls the control valve to supply the boil-off gas to the engine in an amount corresponding to an estimated degree of heavy component concentration of the LNG fuel in the LNG tank, when driving the vehicle with the engine using the LNG fuel.

In another aspect, it is a vehicle equipped with the above fuel supply system.

### Advantageous Effects of Invention

According to the fuel supply system for a vehicle engine of the present invention, it is possible to suppress the discharge of boil-off gas into the atmosphere and to make effective use of the boil-off gas.

### BRIEF DESCRIPTION OF DRAWINGS

FIG. 1 is a diagram showing an example of the configuration of a fuel supply system according to one embodiment of the present invention.

FIG. 2 is a diagram showing an example of the configuration of an ECU according to one embodiment of the present invention.

FIG. 3 is a diagram showing an example of a methane number estimation map.

FIG. 4 is a diagram showing an example of a fuel supply control map.

FIG. 5 is a diagram showing an example of a fuel supply control map.

FIG. 6 is a diagram showing an example of an engine operation control map.

FIG. 7 is a flowchart showing an example of the operation of an ECU according to one embodiment of the present invention.

### DESCRIPTION OF EMBODIMENTS

Hereinafter, a preferred embodiment of the present invention will be described in detail with reference to the accompanying drawings. Note that, in the present specification and drawings, components having substantially the same functions are denoted by the same reference signs, and redundant descriptions are omitted thereby.

### Overall Configuration of Fuel Supply System

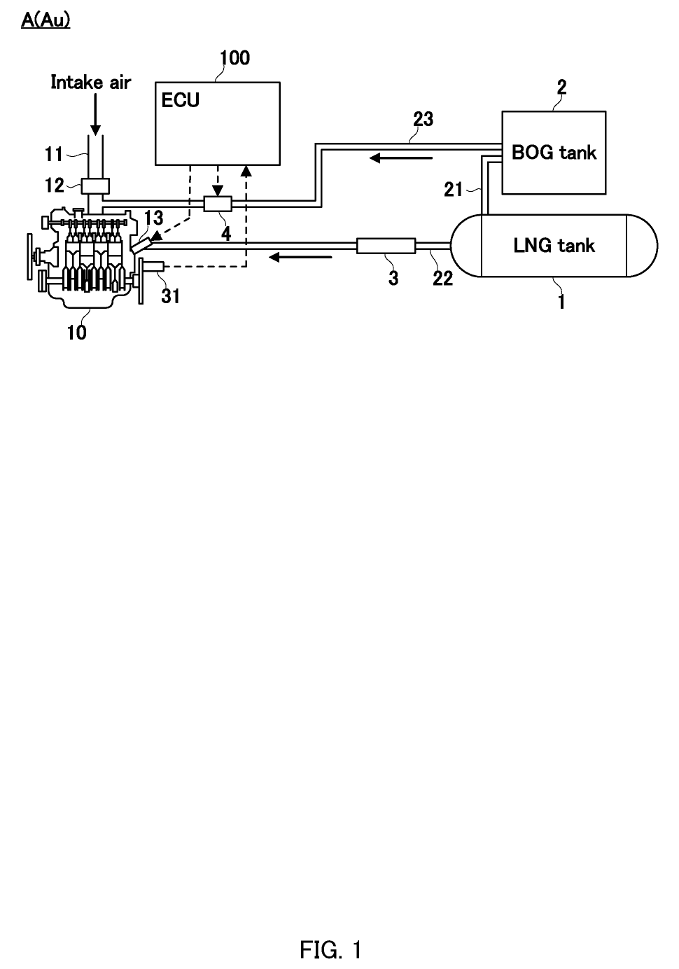

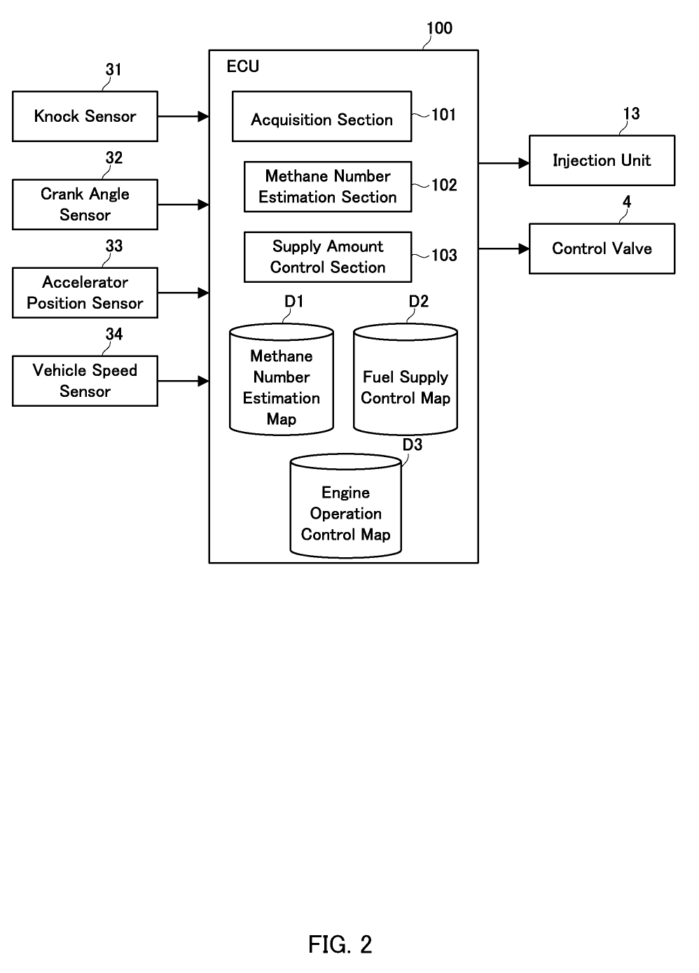

Below, with reference to FIGS. 1-2, a configuration of a fuel supply system (hereinafter referred to as the "fuel supply system Au") installed in a vehicle (hereinafter referred to as "vehicle A") according to one embodiment of the present invention will be described.

FIG. 1 is a diagram showing an example of the configuration of fuel supply system Au.

Fuel supply system Au is installed in vehicle A. Fuel supply system Au is a system for storing LNG fuel, which is fuel for engine 10 of vehicle A, and for supplying the LNG fuel to engine 10.

Engine 10 is a spark-ignition internal combustion engine that burns vaporized LNG fuel by ignition. Engine 10 is typically a four-stroke engine for vehicles and generates power for vehicle A by repeatedly performing an air intake stroke, an air compression stroke, a combustion gas expansion stroke, and a combustion gas exhaust stroke. Engine 10 is, for example, a four-cylinder engine. The power generated by engine 10 is transmitted to the drive wheels via a transmission or the like.

Engine 10 has, for example, injection unit 13 that supplies fuel into the cylinders. Vaporized LNG fuel is introduced into injection unit 13 from LNG tank 1 (more specifically, vaporizer 3), and injection unit 13 pressurizes the vaporized LNG fuel (i.e., LNG gas) and supplies it into the cylinders of engine 10.

Intake pipe 11 is connected to engine 10, and fresh air is introduced into the cylinders of engine 10 through intake pipe 11. Intake throttle valve 12 is provided in intake pipe 11 to adjust the amount of air flowing through intake pipe 11.

Fuel supply system Au includes LNG tank 1, BOG tank 2, vaporizer 3, control valve 4, injection unit 13, knock sensor 31, crank angle sensor 32, accelerator position sensor 33, vehicle speed sensor 34, ECU (Electronic Control Unit) 100, and the like.

FIG. 2 is a diagram showing an example of the configuration of ECU 100. The configuration of fuel supply system Au will be described below with reference to FIGS. 1 and 2.

LNG tank 1 is a pressure-resistant container that stores LNG fuel, which is liquefied natural gas. LNG tank 1 stores the LNG fuel at a temperature at which the natural gas can remain in a liquid state (for example, at or below -162° C., at which natural gas liquefies). A heat insulator is provided inside LNG tank 1. The capacity of LNG tank 1 is, for example, 50 liters, but is not limited to this.

Incidentally, although the heat insulator is provided inside LNG tank 1, atmospheric heat still flows into LNG tank 1 despite the presence of the heat insulator. When ambient heat flows into LNG tank 1, the temperature of the LNG fuel rises, causing the LNG fuel to vaporize and generate boil-off gas. When boil-off gas is generated, the internal pressure of LNG tank 1 increases. The boil-off gas thus generated is sent to BOG tank 2 via first pipe 21 connected to LNG tank 1. That is, in fuel supply system Au according to this embodiment, the boil-off gas generated in LNG tank 1 is stored in BOG tank 2.

The LNG fuel contains, for example, as components, methane (CH4), ethane (C2H6), propane (C3H8), isobutane ((CH3)3CH), n-butane (C4H10), n-pentane (C5H12), nitrogen (N2), carbon dioxide (CO2), etc. The boiling points of the respective components of LNG fuel are different from one another, and methane, which has a lower boiling point, vaporizes first, so the boil-off gas is a gas mainly composed of methane.

Then, the LNG fuel in LNG tank 1 becomes heavier in composition over time as boil-off gas is generated (i.e., the methane number of the LNG fuel decreases). The degree to which the LNG fuel becomes heavier in composition is generally expressed by the methane number. In this embodiment, the methane number of the LNG fuel in an initial state stored in LNG tank 1 (hereinafter referred to as "LNG fuel in an ideal state") is, for example, "60."

First pipe 21 and second pipe 22 are connected to LNG tank 1. First pipe 21 connects LNG tank 1 with BOG tank 2, and serves as a pipe for sending the boil-off gas generated in LNG tank 1 to BOG tank 2. Second pipe 22 connects LNG tank 1 with injection unit 13 of engine 10, and serves as a pipe for supplying the LNG fuel from inside LNG tank 1 to injection unit 13 of engine 10.

First pipe 21 is connected to, for example, the upper part of LNG tank 1, and the boil-off gas generated in LNG tank 1 flows into first pipe 21. Second pipe 22 is connected to, for example, the lower part of LNG tank 1, and the liquid LNG fuel in LNG tank 1 flows into second pipe 22.

Vaporizer 3 is disposed in second pipe 22 between LNG tank 1 and injection unit 13, and heats and vaporizes the liquid LNG fuel supplied from LNG tank 1. Vaporizer 3 is configured, for example, as a heat exchanger that vaporizes the LNG fuel by utilizing the heat of the cooling water of engine 10. That is, a pipe (not shown) through which the cooling water of engine 10 circulates is connected to vaporizer 3, and vaporizer 3 heats the LNG fuel flowing through second pipe 22 by exchanging heat between the cooling water of engine 10 flowing through the pipe and the LNG fuel flowing through second pipe 22. Vaporizer 3 heats the LNG fuel, for example, to a temperature of 40° C. or higher, which is a temperature at which most of the components of the LNG fuel can be vaporized.

The vaporized LNG fuel thus generated by vaporizer 3 is delivered to injection unit 13 of engine 10. The injection operation of injection unit 13 is controlled by ECU 100. The vaporized LNG fuel delivered to injection unit 13 is then supplied into the cylinders of engine 10.

BOG tank 2 is a pressure-resistant container that stores boil-off gas. BOG tank 2 is connected to first pipe 21 extending from LNG tank 1, and stores boil-off gas generated by vaporization of LNG fuel in LNG tank 1. When boil-off gas is generated in LNG tank 1, the pressure inside LNG tank 1 increases, and as a result, the boil-off gas naturally moves to BOG tank 2 via first pipe 21.

BOG tank 2 may be a relatively small container, since the boil-off gas stored in BOG tank 2 is sequentially supplied to engine 10 while engine 10 is running and consumed. The capacity of BOG tank 2 is, for example, 10 liters, but is not limited to this. In order to ensure the storage capacity of boil-off gas, a methane adsorbent material or the like may be disposed in BOG tank 2.

BOG tank 2 and intake pipe 11 of engine 10 are connected by third pipe 23. The boil-off gas stored in BOG tank 2 is supplied as fuel gas to engine 10 via third pipe 23. The boil-off gas is first introduced into intake pipe 11 of engine 10 downstream of intake throttle valve 12 via third pipe 23, and then introduced into the cylinders of engine 10 by utilizing the negative pressure of engine 10.

One end of third pipe 23 is connected to intake pipe 11 at a position downstream of intake throttle valve 12. This ensures that when supplying the boil-off gas into the cylinders of engine 10, the flow path of the boil-off gas is not obstructed by intake throttle valve 12.

Boil-off gas is close to nearly pure methane (methane number: 99) and is useful for returning LNG fuel that has become heavy (i.e., has a reduced methane number) to a normal state. That is, in fuel supply system Au according to this embodiment, the boil-off gas is mixed with the LNG fuel in engine 10, thereby bringing the methane number of the LNG fuel closer to a normal state, thereby suppressing knocking of engine 10.

Control valve 4 is disposed in third pipe 23 and controls the flow of the boil-off gas from BOG tank 2 toward intake pipe 11. Control valve 4 is configured to be able to control the amount of the boil-off gas supplied to intake pipe 11. Control valve 4 controls the amount of the boil-off gas supplied to intake pipe 11, for example, by controlling the pulse width of the valve's on/off operation (i.e., controlling the passage time of the boil-off gas). The opening and closing of control valve 4 is controlled by ECU 100.

As control valve 4, one that controls the supply amount of the boil-off gas to intake pipe 11 by adjusting the valve opening may also be used.

Knock sensor 31 detects the knocking value (i.e., knock frequency) of engine 10. Knock sensor 31 may have any known configuration, for example, it is configured by a piezoelectric element that detects vibrations of engine 10. It is desirable that knock sensor 31 is provided for each of the four cylinders of engine 10. Knock sensor 31 sends the detection result related to the knocking value of engine 10 to ECU 100.

Crank angle sensor 32 detects the engine speed of engine 10. Crank angle sensor 32 sends the detection result relating to the engine speed to ECU 100.

Accelerator position sensor 33 detects the accelerator opening (i.e., required output torque) and sends the detection result relating to the accelerator opening to ECU 100.

Vehicle speed sensor 34 detects the speed of vehicle A. Vehicle speed sensor 34 sends the detection result relating to the vehicle speed to ECU 100.

ECU 100 (corresponding to the "control unit" of the present invention) is an electronic control unit that controls the operation of engine 10, such as the operation of control valve 4 and injection unit 13, and is configured to include, for example, CPU (Central Processing Unit), ROM (Read Only Memory), RAM (Random Access Memory), input ports, output ports, etc. ECU 100 also acquires sensor information from various sensors (in this embodiment, knock sensor 31, crank angle sensor 32, accelerator position sensor 33, and vehicle speed sensor 34) provided in vehicle A, and detects the state of engine 10 and each part of vehicle A.

As shown in FIG. 2, ECU 100 has the functions of acquisition section 101, methane number estimation section 102, and supply amount control section 103. ECU 100 has data such as methane number estimation map D1, fuel supply control map D2, and engine operation control map D3 in a storage unit (e.g., ROM), and uses these data to realize the above functions.

Acquisition section 101 acquires the detection results from the various sensors. Here, acquisition section 101 acquires, for example, the detection result related to the knocking value of engine 10 from knock sensor 31, the detection result related to the engine speed from crank angle sensor 32, the detection result related to the accelerator opening from accelerator position sensor 33, and the detection result related to the vehicle speed from vehicle speed sensor 34.

Methane number estimation section 102 estimates the methane number of the LNG fuel in LNG tank 1 based on the knocking value detected by knock sensor 31. At this time, methane number estimation section 102 estimates the methane number of the LNG fuel (i.e., the degree of heavy component concentration of the LNG fuel) by, for example, referring to methane number estimation map D1 stored in advance in the storage unit. Note that at this time, it is preferable that methane number estimation section 102 estimates the methane number of the LNG fuel by using the average value of the knocking values of each of the four cylinders of engine 10.

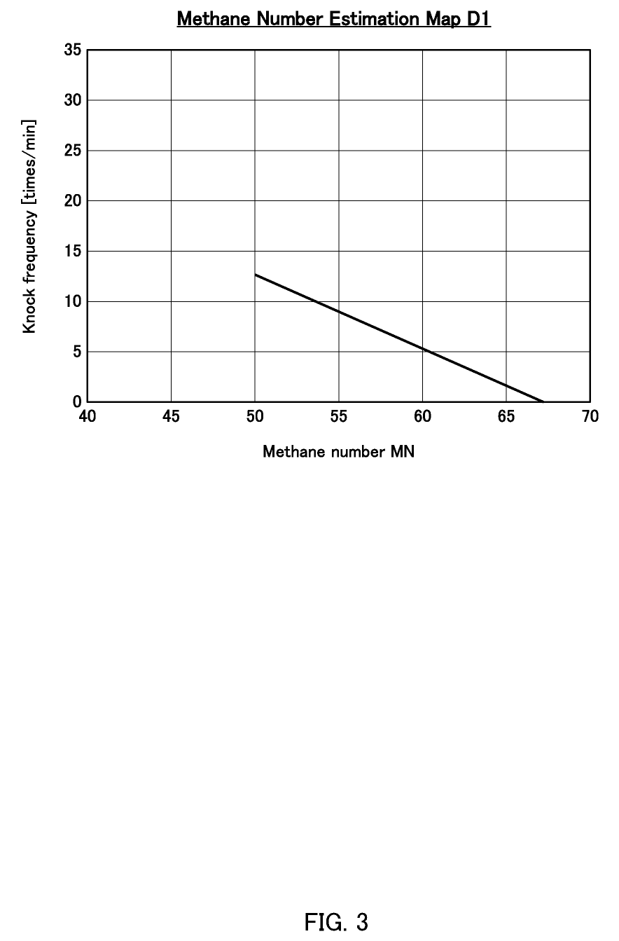

FIG. 3 is a diagram showing an example of methane number estimation map D1. In map D1 shown in FIG. 3, the horizontal direction represents the heavy component concentration index (i.e., methane number) of the LNG fuel, and the vertical direction represents the knock frequency (occurrences/minute). As shown in the map of FIG. 3, generally, the higher the knock frequency (occurrences/minute) in engine 10, the heavier the LNG fuel (i.e., the lower the methane number), and there is a correlation between the two. According to experimental results of the inventors of the present application, the relationship between the knock frequency (occurrences/minute) and the methane number of the LNG fuel is approximately constant, and it is possible to estimate the methane number of the LNG fuel if the knock frequency (occurrences/minute) in engine 10 is known.

Therefore, the inventors of the present application conducted repeated experiments to obtain in advance methane number estimation map D1 that defines the relationship between the knock frequency [times/minute] in engine 10 and the methane number of the LNG fuel, and adopted a configuration in which methane number estimation map D1 is stored in the storage unit (e.g., ROM) of ECU 100. This makes it possible to estimate the methane number of the LNG fuel in LNG tank 1 without installing a large and expensive device such as a methane number sensor in vehicle A.

However, the relationship between the knock frequency [times/minute] in engine 10 and the methane number of the LNG fuel changes slightly depending on the operating state of engine 10 (i.e., the output torque [N m] and the engine speed [rpm]). Therefore, it is desirable to prepare a methane number estimation map D1 for each operating state of engine 10 (e.g., the output torque [N m] and the engine speed [rpm] of engine 10). That is, it is desirable that Methane number estimation section 102 identifies methane number estimation map D1 to be referred based on the output torque [N m] of engine 10 (e.g., the accelerator opening detected by accelerator position sensor 33) and the engine speed [rpm] (e.g., the engine speed detected by crank angle sensor 32), and then estimate the methane number of the LNG fuel currently in LNG tank 1 based on the knocking value detected by knock sensor 31.

Methane number estimation section 102 may express the degree of heavy component concentration of the LNG fuel using another heavy component concentration index (e.g., octane number) that is similar to the methane number.

Supply amount control section 103 controls injection unit 13 to adjust the amount of the LNG fuel supplied to engine 10, and also controls control valve 4 to adjust the amount of the boil-off gas supplied to engine 10.

When vehicle A is driven by engine 10, supply amount control section 103 basically operates engine 10 using the LNG fuel in LNG tank 1. However, if the LNG fuel in LNG tank 1 becomes heavier in composition, supply amount control section 103 uses the LNG fuel and the boil-off gas to ensure the necessary fuel supply amount for the required output of engine 10. In addition, at this time, supply amount control section 103 increases the amount of the boil-off gas supplied to engine 10 as the LNG fuel in LNG tank 1 becomes heavier in composition.

Supply amount control section 103 controls the supply amounts of the LNG fuel and the boil-off gas, for example, based on fuel supply control map D2 stored in advance in the storage unit (for example, ROM) of ECU 100.

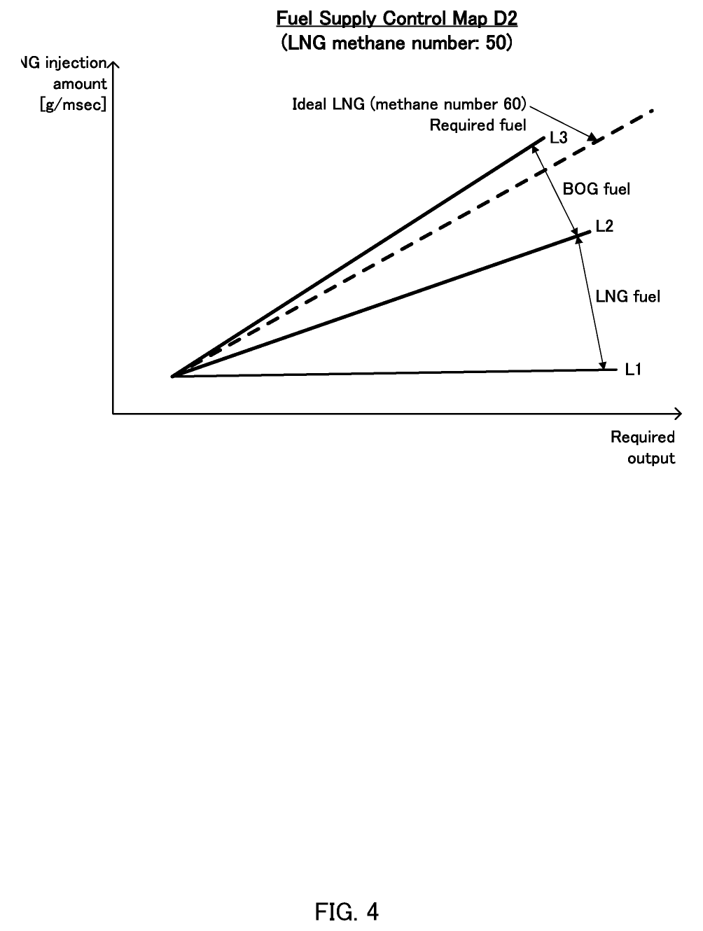

FIG. 4 is a diagram showing an example of fuel supply control map D2. Map D2 of FIG. 4 shows the relationship between the required output (horizontal axis) of engine 10 and the amount of LNG fuel supplied (vertical axis) when the methane number of the LNG fuel in LNG tank 1 is "50." Note that the required output of engine 10 is calculated based on the required output torque [N m] of engine 10 (e.g., the accelerator opening detected by accelerator position sensor 33) and the engine speed [rpm] (e.g., the engine speed detected by crank angle sensor 32).

The dotted line graph in FIG. 4 represents the LNG fuel supply amount [g/msec] when the LNG fuel in LNG tank 1 is in an ideal state (here, methane number '60'). In this case, the supply amount of the boil-off gas is zero.

The solid line graphs L1, L2, and L3 in FIG. 4 represent the LNG fuel supply amount [g/msec] and the boil-off gas supply amount [g/msec] when the LNG fuel in LNG tank 1 has become heavy and its methane number has decreased (here, the methane number is "50"). The solid line graph L1 represents the minimum LNG fuel supply amount that does not depend on the required output. The solid line graph L2 represents the LNG fuel supply amount according to the required output. The solid line graph L3 represents the boil-off gas supply amount according to the required output. In other words, the sum of the LNG fuel supply amount (from 0 to L2) and the boil-off gas supply amount (from L2 to L3) represents the total fuel supply amount. In FIG. 4, the LNG fuel supply amount [g/msec] and the boil-off gas supply amount [g/msec] are values calculated based on the weight of the liquid state.

Since BOG has a small calorific value, in this case (solid line graph), the total fuel supply amount [g/msec] obtained by adding up the LNG fuel supply amount [g/msec] and the boil-off gas supply amount [g/msec] is set to be larger than the total fuel supply amount [g/msec] (dotted line graph) when the required output of engine 10 is satisfied with LNG fuel alone. Furthermore, from the viewpoint of reducing knocking of engine 10, it is desirable that the mixed gas of the LNG fuel and the boil-off gas in the cylinders of engine 10 have a methane number of "60."

From this viewpoint, the ratio of the LNG fuel supply amount [g/msec] to the boil-off gas supply amount [g/msec] is set according to the current methane number of the LNG fuel (in FIG. 4, the methane number is "50").

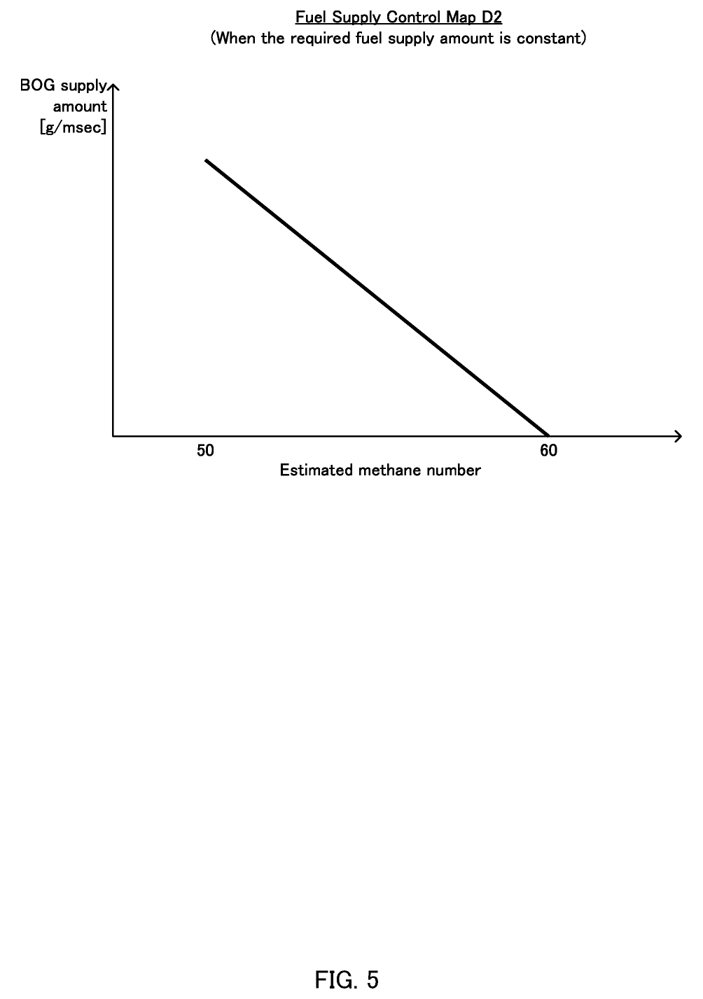

FIG. 5 is a diagram showing an example of fuel supply control map D2 plotting the boil-off gas supply amount [g/msec] based on the estimated methane number of the LNG fuel in LNG tank 1. FIG. 5 shows how the boil-off gas supply amount [g/msec] is adjusted in accordance with the estimated methane number of the LNG fuel in LNG tank 1 under the condition that the required output of engine 10 is constant (i.e., the required fuel supply rate is constant). As can be seen from FIG. 5, supply amount control section 103 increases the boil-off gas supply amount [g/msec] as the LNG fuel in LNG tank 1 becomes heavier in composition. That is, supply amount control section 103 increases the proportion of the boil-off gas supply amount in the required fuel supply amount as the LNG fuel in LNG tank 1 becomes heavier in composition.

As described above, fuel supply system Au according to this embodiment reuses the boil-off gas generated from the LNG fuel as fuel for engine 10 without discharging it into the atmosphere. Furthermore, the boil-off gas can stabilize the methane number of the LNG fuel, which makes it possible to suppress knocking in engine 10.

However, it should be noted that fuel supply system Au according to this embodiment is configured to utilize the engine negative pressure by returning the boil-off gas to intake pipe 11 to supply the boil-off gas to engine 10.

While investigating the use of boil-off gas to suppress knocking, the inventors of the present application considered a configuration in which boil-off gas and LNG fuel are mixed in advance and then introduced into the cylinders of an engine. However, with such a configuration, simply joining the boil-off gas discharge pipe and the LNG discharge pipe makes it difficult to mix them, resulting in an unstable methane number supplied to the cylinders of the engine. In addition, with such a configuration, the pressures of the boil-off gas and the LNG fuel are different, making it impossible to mix the boil-off gas into the vaporized LNG fuel. This necessitates the installation of a compressor or regulator in the boil-off gas discharge pipe for pressure adjustment. In other words, such a configuration not only increases vehicle production costs, but also leads to unstable engine operating conditions due to the different calorific values of LNG and boil-off gas.

In this regard, by adopting a configuration in which the boil-off gas is returned to intake pipe 11 and the engine negative pressure is utilized to supply the boil-off gas to engine 10, as in fuel supply system Au according to this embodiment, the LNG fuel and the boil-off gas are mixed during the combustion process of engine 10. This suppresses instability in the methane number supplied to the cylinders of engine 10 and instability in the operating state of engine 10. In addition, this makes it possible to reuse the boil-off gas in an inexpensive system without providing a compressor or the like for adjusting the pressure.

However, because of this configuration, it is desirable not to supply the boil-off gas to engine 10 while engine 10 is idling, but to supply the boil-off gas to engine 10 only when engine 10 is in off-idle operation (i.e., normal operation). This is because, during idling, the amount of the LNG fuel supplied to engine 10 is very small, and the intake negative pressure of engine 10 is also small (i.e., intake throttle valve 12 is closed), which prevents the LNG combustion from mixing well with the boil-off gas, potentially causing the operating state of engine 10 to become unstable.

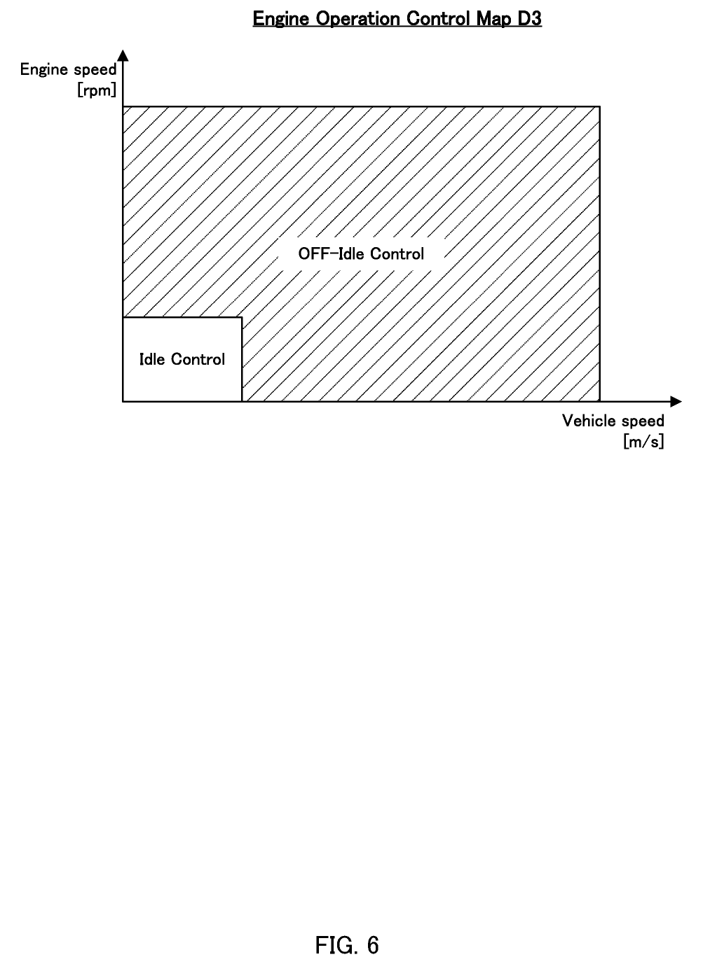

FIG. 6 is a diagram showing an example of engine operation control map D3.

ECU 100 controls engine 10 to switch between an idle operating state and an off-idle operating state in accordance with, for example, engine operating control map D3.

As shown in engine operation control map D3, ECU 100 sets engine 10 to an idle operation state when the vehicle speed is less than a predetermined speed and the engine rotation speed is less than a predetermined rotation speed, and when the above conditions are not met, ECU 100 sets engine 10 to an off-idle operation state.

In the idle operation state, ECU 100 may perform control of the supply of LNG fuel to engine 10 (i.e., the supply amount and supply timing) in a manner different from that performed in the off-idle operation state.

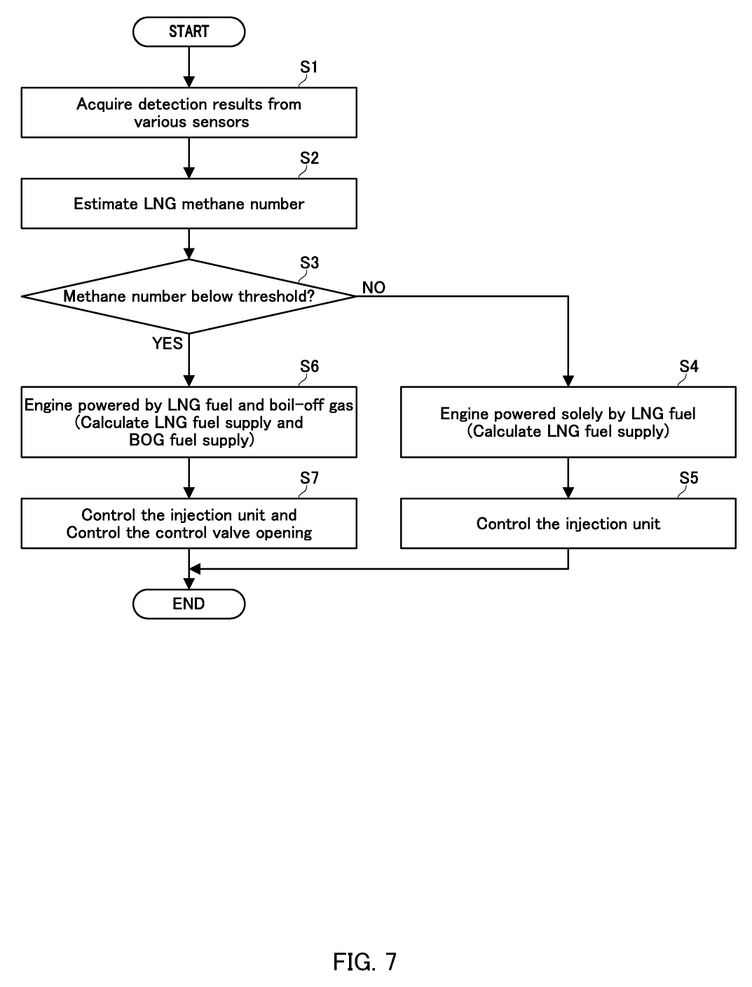

FIG. 7 is a flowchart showing an example of the operation of ECU 100.

The process of the flowchart in FIG. 7 is executed repeatedly at a predetermined frequency (for example, every 100 msec) by ECU 100 when vehicle A is running with engine 10 in an off-idle operating state. However, the process of the flowchart in FIG. 7 is executed only when engine 10 is in an off-idle operating state.

In step S1, ECU 100 acquires detection results from various sensors (such as knock sensor 31, crank angle sensor 32, accelerator position sensor 33, and vehicle speed sensor 34).

In step S2, ECU 100 refers to methane number estimation map D1 and estimates the methane number of the LNG fuel in LNG tank 1 based on the knocking value of engine 10 detected by knock sensor 31. At this time, it is preferable that ECU 100 estimates the methane number of the LNG fuel using the average value of the knocking values of the four cylinders of engine 10.

In step S3, ECU 100 determines whether the estimated methane number of the LNG fuel in LNG tank 1 is less than a threshold value (e.g., "52"). If the estimated methane number of the LNG fuel is less than the threshold value (S3: YES), ECU 100 proceeds to step S6. On the other hand, if the estimated methane number of the LNG fuel is equal to or greater than the threshold value (S3: NO), ECU 100 proceeds to step S4.

In step S4, ECU 100 determines that the LNG fuel in LNG tank 1 is not significantly heavy in composition, and determines to drive engine 10 using only LNG fuel. Then, ECU 100 refers to fuel supply control map D2 and calculates the amount of LNG fuel to be supplied to engine 10 based on the output required for engine 10. ECU 100 determines the output required for engine 10 based on, for example, the accelerator opening and taking into account the engine speed.

In step S5, ECU 100 controls the injection of injection unit 13 so that the LNG fuel supply amount is the amount calculated in step S4. The timing of the injection of the LNG fuel by injection unit 13 is the same as that of a conventionally known technique.

In step S6, ECU 100 determines that the LNG fuel in LNG tank 1 is heavy in composition, and determines to drive engine 10 using the LNG fuel and the boil-off gas. Then, ECU 100 refers to fuel supply control map D2 and calculates the amount of LNG fuel supply and the amount of boil-off gas supply to be supplied to engine 10 based on the required output of engine 10 and the estimated methane number of the LNG fuel calculated in step S2.

In step S7, ECU 100 controls the injection of injection unit 13 and the valve of control valve 4 so that the LNG fuel supply amount and the boil-off gas supply amount are the same as those calculated in step S6. The timing of injecting the LNG fuel from injection unit 13 is the same as that of a conventionally known technique. The timing of supplying the boil-off gas to intake pipe 11 by control valve 4 is not particularly limited, and may be near the intake stroke when engine negative pressure is likely to be effective.

### Effects

In the above embodiment, fuel supply system Au for engine 10 installed in vehicle A is disclosed, fuel supply system Au comprising:

LNG tank 1 for storing LNG fuel;

BOG tank 2 connected to first pipe 21 extending from LNG tank 1 and configured to store boil-off gas vaporized from the LNG fuel in LNG tank 1;

vaporizer 3 connected to a second pipe 22 extending from LNG tank 1 and vaporizing the LNG fuel;

injection unit 13 connected to the vaporizer 3 and configured to inject the vaporized LNG fuel into a cylinder of engine 10;

control valve 4 provided in third pipe 23 connecting BOG tank 2 with intake pipe 11 of engine 10; and

control unit 100 that controls control valve 4 to supply the boil-off gas to engine 10 in an amount corresponding to an estimated degree of heavy component concentration of the LNG fuel in LNG tank 1, when driving vehicle A with the engine using the LNG fuel.

According to fuel supply system Au of this embodiment, boil-off gas generated from LNG fuel can be reused as fuel for engine 10 without being emitted into the atmosphere. Furthermore, according to fuel supply system Au, the boil-off gas can stabilize the methane number of the LNG fuel to be supplied to engine 10, and therefore, it is also possible to suppress knocking in engine 10. In addition, according to fuel supply system Au, the boil-off gas is gradually consumed as fuel for engine 10, so there is no need to provide a large BOG storage tank that would take up storage space inside vehicle A.

Although the specific examples of the present invention have been described in detail above, these are merely examples and do not limit the scope of the claims. The technology described in the claims includes various modifications and changes of the specific examples exemplified above.

This application is entitled to the benefit of Japanese Patent Application No.2025-53436, filed on March 27, 2025, the disclosure of which including the specification, drawings and abstract is incorporated herein by reference in its entirety.

### INDUSTRIAL APPLICABILITY

According to the fuel supply system for a vehicle engine of the present invention, it is possible to suppress the discharge of boil-off gas into the atmosphere and to make effective use of the boil-off gas.

### REFERENCE SIGNS LIST

1 LNG Tank

2 BOG Tank

3 Vaporizer

4 Control Valve

10 Engine

11 Intake Pipe

12 Intake Throttle Valve

13 Injection Unit

21 First Pipe

22 Second Pipe

23 Third Pipe

31 Knock Sensor

32 Crank Angle Sensor

33 Accelerator Position Sensor

34 Vehicle Speed Sensor

100 ECU (Control Unit)

101 Acquisition Section

102 Methane Number Estimation Section

103 Supply Amount Control Section

A Vehicle

Au Fuel Supply System

D1 Methane Number Estimation Map

D2 Fuel Supply Control Map

D3 Engine Operation Control Map

1. A fuel supply system for an engine installed in a vehicle, the fuel supply system comprising:
an LNG tank for storing LNG (Liquefied Natural Gas) fuel;
a boil-off gas (BOG) tank connected to a first pipe extending from the LNG tank and configured to store boil-off gas vaporized from the LNG fuel in the LNG tank;
a vaporizer connected to a second pipe extending from the LNG tank and vaporizing the LNG fuel;
an injection unit connected to the vaporizer and configured to inject the vaporized LNG fuel into a cylinder of the engine;
a control valve provided in a third pipe connecting the BOG tank with an intake pipe of the engine; and
a control unit that controls the control valve to supply the boil-off gas to the engine in an amount corresponding to an estimated degree of heavy component concentration of the LNG fuel in the LNG tank, when driving the vehicle with the engine using the LNG fuel.

2. The fuel supply system according to claim 1, wherein the control unit estimates the degree of heavy component concentration of the LNG fuel in the LNG tank based on a knocking value detected by a knock sensor installed in the engine.

3. The fuel supply system according to claim 2, wherein the control unit estimates the degree of heavy component concentration of the LNG fuel in the LNG tank as the methane number of the LNG fuel.

4. The fuel supply system according to claim 1, wherein the control unit increases the supply amount of the boil-off gas supplied to the engine as the LNG fuel in the LNG tank becomes heavier in composition.

5. The fuel supply system according to claim 1, wherein
the control unit ensures a necessary fuel supply amount for a required output of the engine using the LNG fuel and the boil-off gas, and increases a proportion of the boil-off gas supply amount in the necessary fuel supply amount as the LNG fuel in the LNG tank becomes heavier in composition.

6. The fuel supply system according to claim 1, wherein
the control unit supplies the boil-off gas to the engine when the engine is in an off-idle operating state.

7. A vehicle equipped with the fuel supply system according to claim 1.
